(19) United States
(12) Patent Application Publication
(10) Pub. No.: US 2013/0219317 A1
(43) Pub. Date: Aug. 22, 2013

(54) ULTRASONIC DIAGNOSIS DEVICE AND CONTROLLING METHOD THEREOF

(71) Applicants: Dong Min Jo, Seoul (KR); Jin Yong Park, Seoul (KR)

(72) Inventors: Dong Min Jo, Seoul (KR); Jin Yong Park, Seoul (KR)

(73) Assignee: ALPINION MEDICAL SYSTEMS CO., LTD., Hwaseong-si, Gyeonggi-do (KR)

(21) Appl. No.: 13/704,547

(22) PCT Filed: May 23, 2011
(86) PCT No.: PCT/KR11/03764

§ 371 Date: Dec. 14, 2012

(30) Foreign Application Priority Data
Jun. 14, 2010 (KR) 10-2010-0055890

(51) Int. Cl. G06F 19/00

(52) U.S. Cl. CPC G06F 19/3406
USPC 715/771

(57) ABSTRACT

An ultrasonic diagnostic apparatus includes: a control panel including a plurality of character input keys provided for character input, and one or more function selection keys provided for function selection; a selection menu providing unit for providing a selection menu for selecting a character type corresponding to the character input keys of the control panel and a function type corresponding to the function selection keys of the control panel; and a control unit for performing a control operation for inputting a character corresponding to a selected character type or executing a function corresponding to a selected function type, in response to one or more of the character type and the function type selected from the selection menu.

### TECHNICAL FIELD

The present disclosure relates in some embodiments to an ultrasonic diagnostic apparatus and a controlling method thereof. More particularly, the present disclosure relates to an ultrasonic diagnostic apparatus and a controlling method thereof for allowing a variety of characters to be selectively inputted within a limited number of character input keys or a variety of functions to be selectively performed within a limited number of function selection keys, as well as allowing a user to arbitrarily change the character/functional sequence of the fixed hardware arrangement of character input keys or function selection keys.

### BACKGROUND

The statements in this section merely provide background information related to the present disclosure and may not constitute prior art.

An ultrasonic diagnostic apparatus is a type of an inspection apparatus that irradiates ultrasonic wave on an inspection site of an object (for example, human body), detects a time difference between the irradiated ultrasonic wave and rebound echo reflected from the interior, converts the detected time difference to a distance by using an electronic circuit, and images the inspection site of the object. The ultrasonic wave used in the ultrasonic diagnostic apparatus is harmless to humans. Therefore, the ultrasonic diagnostic apparatus is particularly useful for medical purpose and is widely used for detection of foreign substance inside human body, determination of damage degree, and observation of tumor or fetus.

On the other hand, as digital electronic technologies have recently developed, the functions and inspection capability of ultrasonic diagnostic apparatuses have greatly enhanced. In order to sufficiently utilize such enhanced functions, a configuration of a control panel has become complicated.

FIG. 1 is a schematic diagram showing a control panel of a conventional ultrasonic diagnostic apparatus. Referring to FIG. 1, the control panel 100 of the conventional ultrasonic diagnostic apparatus includes a plurality of character input keys 110 for inputting patient information and other information in characters, one or more function selection keys 120 for selecting additional functions of the ultrasonic diagnostic apparatus, an image adjustment unit 130 for displaying an image obtained through an ultrasonic wave on a display (not shown) and adjusting the displayed image, and a variable information adjustment unit 140 for varying input information within a predetermined range. However, the components of the control panel 100 of the ultrasonic diagnostic apparatus are not limited to those described above. The control panel 100 may further include a touch pad, a track ball, and the like for use as a computer mouse.

In the components of the control panel 100 of the ultrasonic diagnostic apparatus, characters are set to the plurality of character input keys 110, just like a computer keyboard, and the character input keys 110 can display the characters corresponding to the character input keys selected by a user and store the characters.

In addition, the function selection key 120 configures a function frequently used for manipulation of the ultrasonic diagnostic apparatus by using a control key, such that the corresponding function is executed at a time. The function selection key 120 may display an image, icon or character implying the function of the function selection key 120, so that a user can know which function the corresponding key executes.

However, in the conventional ultrasonic diagnostic apparatus, as shown in FIG. 1, characters which can be inputted by each character input key or functions which can be selected by the function selection key is fixed in hardware. Therefore, in order to enable the additional input of a new character which is not provided on the arrangement of the plurality of character input keys or the additional selection of a new function which is not provided on the arrangement of the plurality of function selection keys, it is necessary to additionally install a new character input key or function selection key, separately from the existing character input key or function selection keys.

In addition, in the conventional ultrasonic diagnostic apparatus, as shown in FIG. 1, the arrangement of the character input keys and the arrangement of the function selection keys are fixed in hardware. Therefore, the user cannot arbitrarily change the arrangement of the character input keys or the arrangement of the function selection keys.

### DISCLOSURE

### Technical Problem

Therefore, the present disclosure is directed to provide an ultrasonic diagnostic apparatus and a controlling method thereof for allowing a variety of characters to be selectively inputted within a limited number of character input keys or a variety of functions to be selectively performed within a limited number of function selection keys.

In addition, the present disclosure is directed to provide an ultrasonic diagnostic apparatus and a controlling method thereof for allowing a user to arbitrarily change the character/functional sequence of the fixed hardware arrangement of character input keys or function selection keys.

### SUMMARY

An aspect of the present disclosure provides an ultrasonic diagnostic apparatus including: a control panel including a plurality of character input keys provided for character input, and one or more function selection keys provided for function selection; a selection menu providing unit for providing a selection menu for selecting a character type corresponding to the character input keys of the control panel and a function type corresponding to the function selection keys of the control panel; and a control unit for performing a control operation for inputting a character corresponding to a selected character type or executing a function corresponding to a selected function type, in response to one or more of the character type and the function type selected from the selection menu.

The ultrasonic diagnostic apparatus may further include a display for displaying a character arrangement corresponding to the selected character type or a function arrangement corresponding to the selected function type.

The character input keys may include a character display unit for displaying a character corresponding to the selected character type.

The function selection keys may include a function display unit for displaying a function corresponding to the selected character type.

The character display unit or the function display unit may include an organic light emitting diode (OLED).

The ultrasonic diagnostic apparatus may further include an arrangement selecting unit for selecting a character arrangement corresponding to the selected character type or a function arrangement corresponding to the selected function type.

Another embodiment of the present disclosure provides an ultrasonic diagnostic apparatus including: a control panel including a plurality of character input keys provided for character input and one or more function selection keys provided for function selection and configured to display a character corresponding to each of the character input keys and a function corresponding to each of the function selection keys; a selection menu providing unit for providing a selection menu foe selecting a character type corresponding to the character input keys and a function type corresponding to the function selection keys; and a control unit for performing a control operation for displaying a character corresponding to a selected character type or a function corresponding to a selected function type on said each of the character input keys or said each of the function selection keys, in response to one or more of the character type and the function type selected from the selection menu.

The character input keys and the function selection keys may include an organic light emitting diode (OLED), respectively.

The ultrasonic diagnostic apparatus may further include an arrangement selecting unit for selecting a character arrangement corresponding to the selected character type or a function arrangement corresponding to the selected function type.

Yet another embodiment of the present disclosure provides a method for controlling an ultrasonic diagnostic apparatus, which includes a plurality of character input keys provided for character input and one or more function selection keys provided for function selection, the method including: providing a selection menu for selecting a character type corresponding to the character input keys and a function type corresponding to the function selection keys; and performing a control operation for inputting a character corresponding to a selected character type or carrying out a function corresponding to a selected function type, in response to one or more of the character type and the function type selected from the selection menu.

The method may further include displaying a character arrangement corresponding to the selected character type or a function arrangement corresponding to the selected function type on a display.

A character corresponding to the selected character type may be displayed by each of the character input keys. A function corresponding to the selected function type may be displayed by each of the function selection keys. The character input keys or the function selection keys may include an OLED.

The method may further include selecting a character arrangement corresponding to the selected character type or a function arrangement corresponding to the selected function type.

Yet another embodiment of the present disclosure provides a method for controlling an ultrasonic diagnostic apparatus, which includes a plurality of character input keys provided for character input and one or more function selection keys provided for function selection, the method including: providing a selection menu for selecting a character type corresponding to the character input keys and a function type corresponding to the function selection keys; and performing a control operation for displaying a character corresponding to a selected character type or a function corresponding to a selected function type from each of the character input keys or each of the function selection keys, in response to one or more of the character type and the function type selected from the selection menu.

The character input keys and the function selection keys may include an organic light emitting diode (OLED), respectively.

The method may further include arranging a character corresponding to the selected character type or a function corresponding to the selected function type.

### Advantageous Effects

According to the present disclosure as described above, a user can selectively input a variety of characters within a limited number of character input keys or can selectively perform a variety of functions within a limited number of function selection keys.

In addition, according to the present disclosure, a user can arbitrarily change the character/functional sequence of the fixed hardware arrangement of character input keys or function selection keys.

### DESCRIPTION OF DRAWINGS

FIG. 1 is a schematic diagram showing a control panel of a conventional ultrasonic diagnostic apparatus;

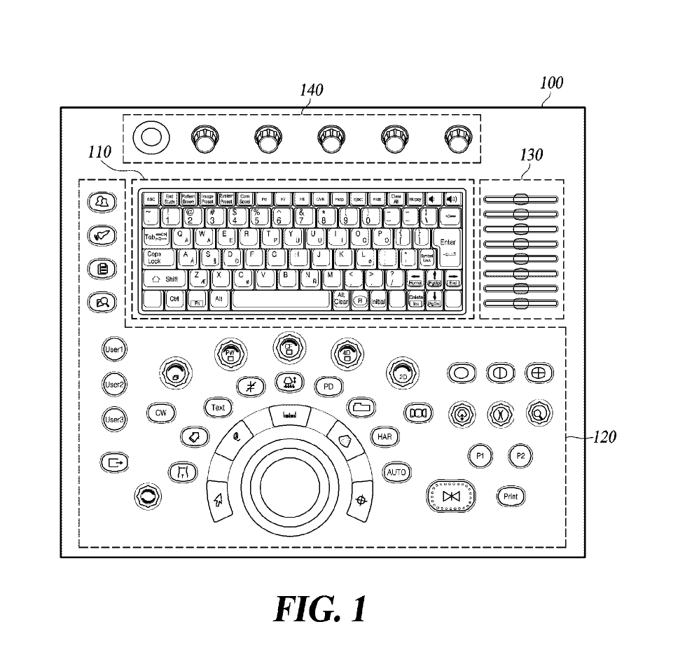

FIG. 2 is a schematic diagram showing a configuration of an ultrasonic diagnostic apparatus according to an embodiment of the present disclosure;

FIG. 3 is a schematic diagram showing a configuration of an ultrasonic diagnostic apparatus according to another embodiment of the present disclosure;

FIG. 4 is a diagram showing an example of a character input key in the ultrasonic diagnostic apparatus of FIG. 3;

FIG. 5 is a diagram showing an example of a function selection key in the ultrasonic diagnostic apparatus of FIG. 3;

FIG. 6 is a flow diagram showing an example of a method for controlling an ultrasonic diagnostic apparatus according to an embodiment of the present disclosure; and

FIG. 7 is a flow diagram showing another example of the method for controlling an ultrasonic diagnostic apparatus according to the embodiment of the present disclosure.

### DETAILED DESCRIPTION

Hereinafter, embodiments of the present disclosure will be described in detail with reference to the accompanying drawings. In the following description, like reference numerals designate like elements although they are shown in different drawings. Further, in the following description of the present embodiments, a detailed description of known functions and configurations incorporated herein will be omitted for the purpose of clarity.

Additionally, in describing the components of the present disclosure, there may be terms used like first, second, A, B, (a), and (b). These are solely for the purpose of differentiating one component from the other but not to imply or suggest the substances, order or sequence of the components. If a component were described as ‘connected’, ‘coupled’, or ‘linked’ to another component, they may mean the components are not only directly ‘connected’, ‘coupled’, or ‘linked’ but also are indirectly ‘connected’, ‘coupled’, or ‘linked’ via a third component.

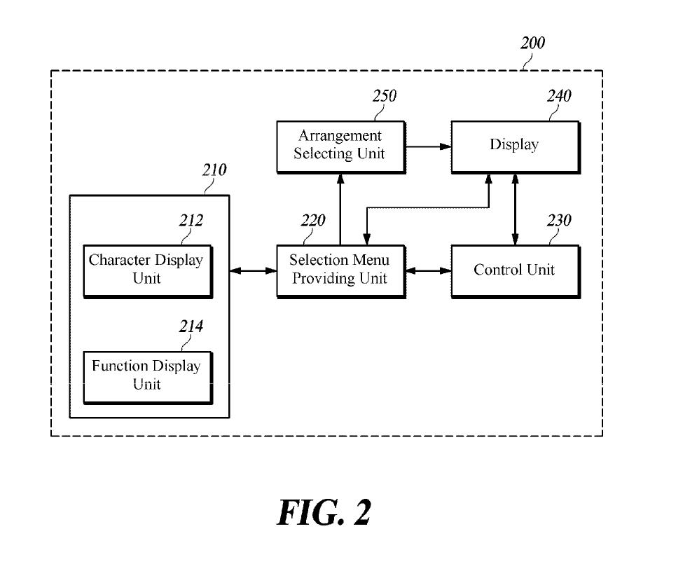

FIG. 2 is a schematic diagram showing a configuration of an ultrasonic diagnostic apparatus according to an embodiment of the present disclosure. Referring to FIG. 2, the ultrasonic diagnostic apparatus according to the embodiment of the present invention may include a control panel 210, a selection menu providing unit 220, a control unit 230, a display 240, and an arrangement selecting unit 250.

The control panel 210 includes a plurality of character input keys provided for character input, and one or more function selection keys provided for function selection.

The selection menu providing unit 220 provides a selection menu about a character type corresponding to the character input keys and a function type corresponding to the function selection keys. For example, the selection menu providing unit 220 may provide a selection menu about a character type for input of language, such as Korean, English, Japanese, Chinese, and Russian, according to the plurality of character input keys, as well as a selection menu about a character type for use of a program, such as Photoshop and Illustrator. In addition, the selection menu providing unit 220 may provide a selection menu about a function type for performing additional functions of the ultrasonic diagnostic apparatus, such as body pattern measurement and program update. The selection menu providing unit 220 may display each selection menu on the control panel 210 and implement the selection menu in a switch form so that the user can switch and select the selection menu, or may display the selection menu on the display 240 and allow the user to select the selection menu.

When the user selects a character type or a function type based on the selection menu provided by the selection menu providing unit 220, the control unit 230 perform control such that a character corresponding to the selected character type is inputted, or a function corresponding to the selected function type is performed. For example, when English is selected in the character type provided by the selection menu providing unit 220, the control unit 230 performs control such that information inputted through the character input keys by the user can be inputted in English. When body pattern is selected, the control unit 230 performs control such that a relevant ultrasonic diagnosis is performed.

The display 240 can display the selection menu about the character type or the function type provided by the selection menu providing unit 220. In addition, when the user selects the character type or the function type based on the provided selection menu, the display 240 may display the character arrangement corresponding to the selected character type or the function arrangement corresponding to the selected function type. It has been described that the selection menu, the character arrangement corresponding to the selected character type, and the function arrangement corresponding to the selected function type are displayed on the display 240. However, instead of displaying the character arrangement corresponding to the selected character type, and the function arrangement corresponding to the selected function type, the display 240 may include a character display unit 212 allowing each character input key to display characters corresponding to the character type, and a function display unit 214 allowing each function selection unit to display icons, characters, and symbols representing the function type. In this case, the character display unit 212 and the function display unit 214 may be implemented with organic light emitting diodes (OLEDs). The OLED is a self-luminous organic material that emits light by itself by using electroluminescence phenomenon that light is emitted when a current flows through a fluorescent organic compound. The OLED is also called an organic light emitting diode or an organic EL. Since the OLED can be driven at a low voltage and made in a slim profile, the OLED can be formed on each character input key and each function selection key.

The arrangement selecting unit 250 provides an arrangement selection menu about the character arrangement corresponding to the character type selected by the user or the function arrangement corresponding to the function type selected by the user, among the selection menus provided by the selection menu providing unit 220. Therefore, the user is allowed to select the character arrangement or the function arrangement. For example, when the user selects English in the selection menu about the character type, the arrangement selecting unit 250 provides various arrangement selection menus, such as qwerty layout or dvorak layout, with respect to the selected character type, that is, English alphabet arrangement, and can allow characters to be inputted according to the arrangement selected by the user.

In this manner, the user can arbitrarily change the character type, the function type, and the arrangements thereof according to the user's selection, while watching the selection menu displayed on the display, the character arrangement corresponding to the selected character type, or the function arrangement corresponding to the selected function type.

In addition, according to the present disclosure, various character types or various function types may be additionally provided without hardware expansion within a limited number of character input keys or a limited number of function selection keys.

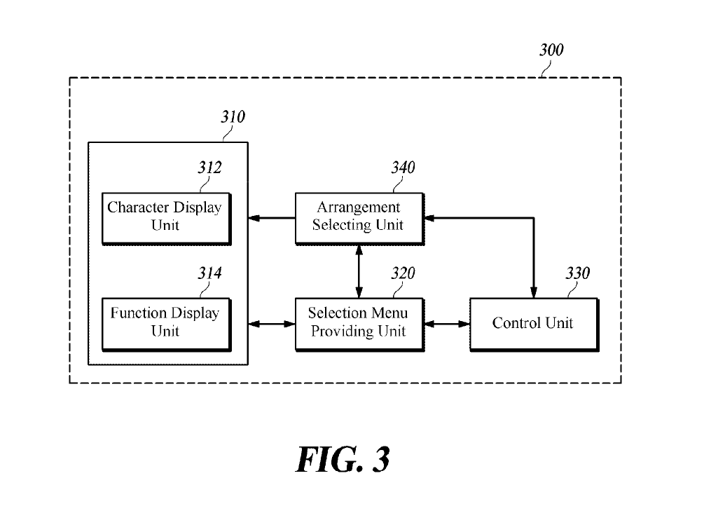

FIG. 3 is a schematic diagram showing an ultrasonic diagnostic apparatus according to another embodiment of the present disclosure. Referring to FIG. 3, the ultrasonic diagnostic apparatus according to another embodiment of the present invention may include a control panel 310, a selection menu providing unit 320, a control unit 330, an arrangement selecting unit 340. As in the case of FIG. 2, the control panel 310 includes a plurality of character input keys provided for character input, and one or more function selection keys provided for function selection. In this case, each character input key includes a character display unit 312 implemented with an OLED on the top surface thereof and capable of switching and displaying various types of character. In addition, each function selection key includes a function display unit 314 implemented with an OLED on the top surface thereof and capable of is switching and displaying various types of function.

The selection menu providing unit 320 provides a selection menu for a character type corresponding to the character input keys and a function type corresponding to the function selection keys in the control panel 310. The selection menu providing unit 320 may display each selection menu on the control panel 310 and implement the selection menu in a switch shape so that the user can switch and select the selection menu, or may display the selection menu on the display and allow the user to select the selection menu.

When the user selects one or more of the types of character and the types of function based on the selection menu provided by the selection menu providing unit 320, the control unit 330 performs control such that a character corresponding to the selected character type or a function corresponding to the selected function type are displayed on the character input key or the function selection key.

The arrangement selecting unit 340 is implemented such that a character arrangement corresponding to the selected character type and a function arrangement corresponding to the selected function type can be selected. The arrangement selecting unit 340 performs control such that the character arrangement displayed on the character display unit 312 or the function arrangement displayed on the function display unit 314 is changed according to the character arrangement or function arrangement selected by the user.

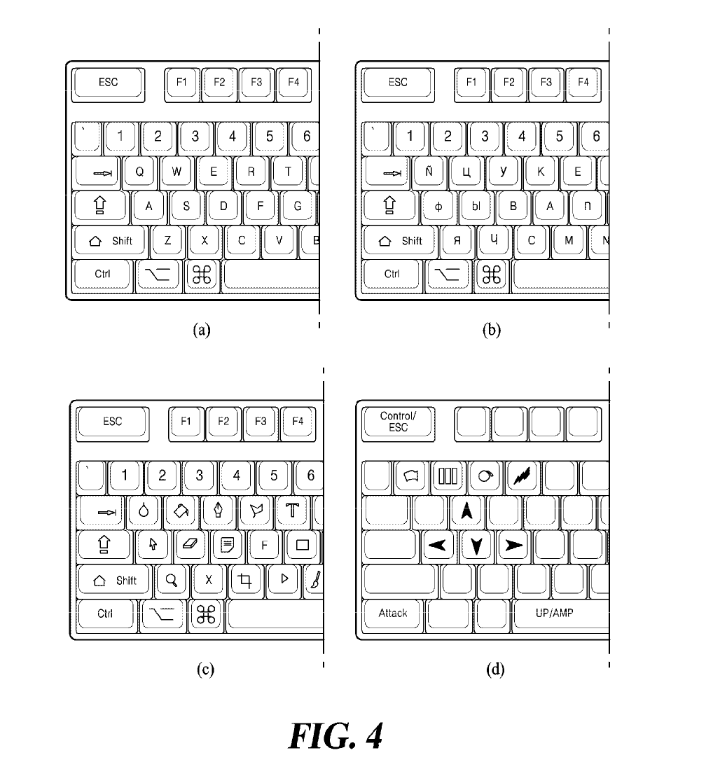

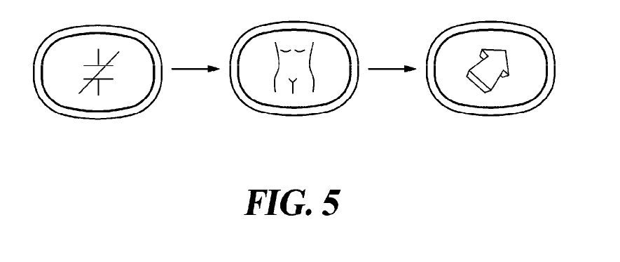

In this manner, the user can change the character type to another type, while watching the character type displayed on the character display unit. For example, as shown in FIG. 4, the user can change the character input key displayed on the character display unit 312 in English (see FIG. 4A) to Russian (see FIG. 4B), or may change the function selection key to the function selection key for use of Photoshop (see FIG. 4C), or change to the function selection key for other purpose (see FIG. 4D). In addition, as shown in FIG. 5, the user can change the function selection key to other function while watching the icon representing the function type displayed on the function display unit 314.

In addition, according to the present disclosure, various types of characters or various types of functions may be additionally provided without hardware expansion within a limited number of character input keys or a limited number of function selection keys.

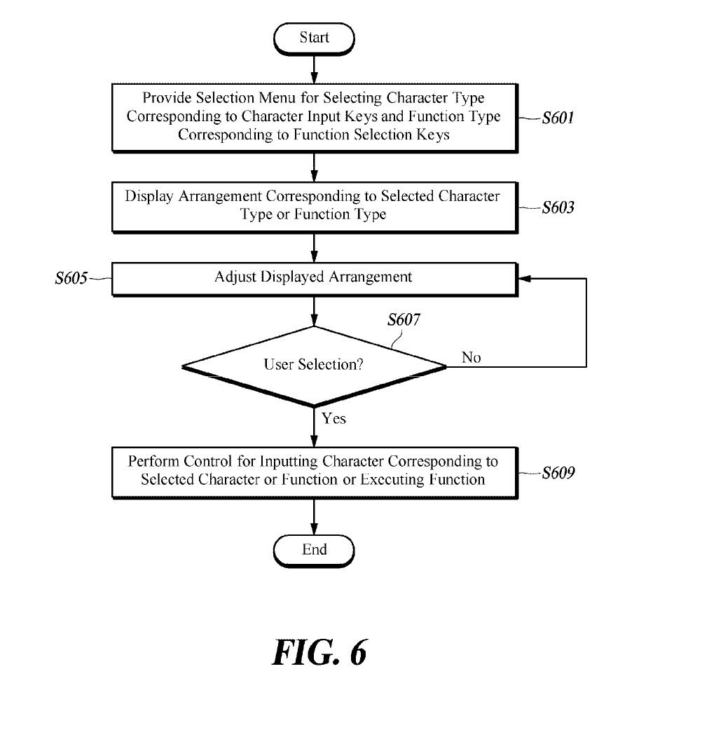

FIG. 6 is a flow diagram showing an example of a method for controlling an ultrasonic diagnostic apparatus according to an embodiment of the present disclosure. The method for controlling the ultrasonic diagnostic apparatus of FIG. 2 will be described as an example.

Referring to FIG. 6, the selection menu providing unit 220 provides a selection menu for selecting a character type corresponding to character input keys and a function type corresponding to function selection keys in the control panel 210 (S601).

In this case, the display 240 can display the character arrangement corresponding to the selected character type or the function arrangement corresponding to the selected function type, based on the selection menu (S603). In addition, the character corresponding to the selected character type can be displayed through the character display unit 212 provided in each character input key, and the function corresponding to the selected function type can be displayed through the function display unit 214 provided in the function selection key.

The arrangement selecting unit 250 may provide an arrangement selection menu for allowing the user to select the character arrangement corresponding to the character type or the function arrangement corresponding to the function type, which is displayed on the display 240 (S605).

The control unit 230 performs control for matching the character arrangement corresponding to the character type and the function arrangement corresponding to the function type, which are displayed on the display 240, with the relevant character input keys and function selection keys, respectively.

In addition, when the user selects the character input key or the function selection key based on the character arrangement corresponding to the character type or the function arrangement corresponding to the function type, which is displayed on the display 240 (S607), the control unit 230 performs control for inputting the character corresponding to the selected character input key or executing the function corresponding to the selected function selection key (S609).

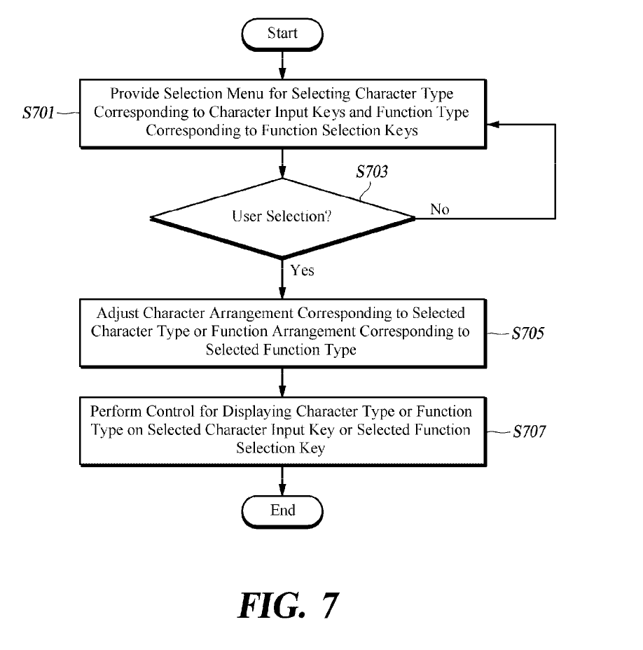

FIG. 7 is a flow diagram showing another example of a method for controlling the ultrasonic diagnostic apparatus according to the embodiment of the present disclosure. The method for controlling the ultrasonic diagnostic apparatus of FIG. 3 will be described as an example.

Referring to FIG. 7, the selection menu providing unit 320 provides the selection menu for selecting the character type corresponding to the character input keys and the function type corresponding to the function selection keys in the control panel 310 (S701). In this case, each character input key includes the character display unit 312 so as to display the character, and each function selection key includes the function display unit 314 so as to display the function. When the user selects the character type or the function type, based on the selection menu provided by the selection menu providing unit 320 (S703), the character display unit 312 or the function display unit 314 displays the character corresponding to the selected character type or the function corresponding to the selected function type.

The arrangement selecting unit 340 can change and adjust the character arrangement displayed through the character display unit 312 provided in each character input key or the function arrangement displayed through the function display unit 314 provided in each function selection key (S705).

When the user selects the character type or the function type, based on the selection menu, the control unit 330 performs control for displaying the selected character type and the selected function type correspondingly on the character input keys and the function selection keys, respectively (S707). In addition, when the user adjusts the character arrangement displayed on the character input key or the function arrangement displayed on the function selection key, based on the arrangement selection menu, the control unit 330 performs control for displaying the character rearrangement or the function rearrangement on the character input keys or the function selection keys, respectively.

In the description above, although all of the components of the embodiments of the present disclosure may have been explained as assembled or operatively connected as a unit, the present disclosure is not intended to limit itself to such embodiments. Rather, within the objective scope of the present disclosure, the respective components may be selectively and operatively combined in any numbers. Every one of the components may be also implemented by itself in hardware while the respective ones can be combined in part or as a whole selectively and implemented in a computer program having program modules for executing functions of the hardware equivalents. Codes or code segments to constitute such a program may be easily deduced by a person skilled in the art. The computer program may be stored in computer readable media, which in operation can realize the embodiments of the present disclosure. As the computer readable media, the candidates include magnetic recording media, optical recording media, and carrier wave media.

In addition, terms like ‘include’, ‘comprise’, and ‘have’ should be interpreted in default as inclusive or open rather than exclusive or closed unless expressly defined to the contrary. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

Although exemplary embodiments of the present disclosure have been described for illustrative purposes, those skilled in the art will appreciate that various modifications, additions and substitutions are possible, without departing from essential characteristics of the disclosure. Therefore, exemplary embodiments of the present disclosure have not been described for limiting purposes. Accordingly, the scope of the disclosure is not to be limited by the above embodiments but by the claims and the equivalents thereof.

### CROSS-REFERENCE TO RELATED APPLICATION

If applicable, this application claims priority under 35 U.S.C §119(a) of Patent Application No. 10-2010-0055890, filed on Jun. 14, 2010 in Korea, the entire content of which is incorporated herein by reference. In addition, this non-provisional application claims priority in countries, other than the U.S., with the same reason based on the Korean Patent Application, the entire content of which is hereby incorporated by reference.

1. An ultrasonic diagnostic apparatus comprising:
a control panel including a plurality of character input keys provided for character input, and one or more function selection keys provided for function selection;
a selection menu providing unit for providing a selection menu for selecting a character type corresponding to the character input keys of the control panel and a function type corresponding to the function selection keys of the control panel; and
a control unit for performing a control operation for inputting a character corresponding to a selected character type or executing a function corresponding to a selected function type, in response to one or more of the character type and the function type selected from the selection menu.

2. The ultrasonic diagnostic apparatus of claim 1, further comprising a display for displaying a character arrangement corresponding to the selected character type or a function arrangement corresponding to the selected function type.

3. The ultrasonic diagnostic apparatus of claim 1, wherein the character input keys include a character display unit for displaying a character corresponding to the selected character type.

4. The ultrasonic diagnostic apparatus of claim 1, wherein the function selection keys include a function display unit for displaying a function corresponding to the selected character type.

5. The ultrasonic diagnostic apparatus of claim 3, wherein the character display unit or the function display unit comprises an organic light emitting diode (OLED).

6. The ultrasonic diagnostic apparatus of claim 1, further comprising an arrangement selecting unit for selecting a character arrangement corresponding to the selected character type or a function arrangement corresponding to the selected function type.

7. An ultrasonic diagnostic apparatus comprising:
a control panel including a plurality of character input keys provided for character input and one or more function selection keys provided for function selection and configured to display a character corresponding to each of the character input keys and a function corresponding to each of the function selection keys;
a selection menu providing unit for providing a selection menu for selecting a character type corresponding to the character input keys and a function type corresponding to the function selection keys; and
a control unit for performing a control operation for displaying a character corresponding to a selected character type or a function corresponding to a selected function type on said each of the character input keys or said each of the function selection keys, in response to one or more of the character type and the function type selected from the selection menu.

8. The ultrasonic diagnostic apparatus of claim 7, wherein the character input keys or the function selection keys comprise an organic light emitting diode (OLED), respectively.

9. The ultrasonic diagnostic apparatus of claim 7, further comprising an arrangement selecting unit for selecting a character arrangement corresponding to the selected character type or a function arrangement corresponding to the selected function type.

10. A method for controlling an ultrasonic diagnostic apparatus, which includes a plurality of character input keys provided for character input and one or more function selection keys provided for function selection, the method comprising:
providing a selection menu for selecting a character type corresponding to the character input keys and a function type corresponding to the function selection keys; and
performing a control operation for inputting a character corresponding to a selected character type or carrying out a function corresponding to a selected function type, in response to one or more of the character type and the function type selected from the selection menu.

11. The method of claim 10, further comprising displaying a character arrangement corresponding to the selected character type or a function arrangement corresponding to the selected function type on a display.

12. The method of claim 10, wherein a character corresponding to the selected character type is displayed by each of the character input keys.

13. The method of claim 10, wherein a function corresponding to the selected function type is displayed by each of the function selection keys.

14. The method of claim 12, wherein the character input keys or the function selection keys comprise an OLED.

15. The method of claim 10, further comprising selecting a character arrangement corresponding to the selected character type or a function arrangement corresponding to the selected function type.

16. A method for controlling an ultrasonic diagnostic apparatus, which includes a plurality of character input keys provided for character input and one or more function selection keys provided for function selection, the method comprising:
providing a selection menu for selecting a character type corresponding to the character input keys and a function type corresponding to the function selection keys; and
performing a control operation for displaying a character corresponding to a selected character type or a function corresponding to a selected function type from each of the character input keys or each of the function selection keys, in response to one or more of the character type and the function type selected from the selection menu.

17. The method of claim 16, wherein the character input keys and the function selection keys comprise an organic light emitting diode (OLED), respectively.

18. The method of claim 16, further comprising arranging a character corresponding to the selected character type or a function corresponding to the selected function type.

19. The ultrasonic diagnostic apparatus of claim 4, wherein the character display unit or the function display unit comprises an organic light emitting diode (OLED).

20. The method of claim 13, wherein the character input keys or the function selection keys comprise an OLED.
